(19) United States
(12) Patent Application Publication
(10) Pub. No.: US 2016/0144535 A1
(43) Pub. Date: May 26, 2016

(54) SHAPING TABLE FOR THREE-DIMENSIONAL SHAPING DEVICE, THREE-DIMENSIONAL SHAPING DEVICE, AND METHOD OF MANUFACTURING SHAPED OBJECT

(71) Applicant: MUTOH INDUSTRIES LTD., Tokyo (JP)

(72) Inventor: Takashi Touma, Tokyo (JP)

(21) Appl. No.: 14/947,798

(22) Filed: Nov. 20, 2015

(30) Foreign Application Priority Data
Nov. 21, 2014 (JP) 2014-236585

(51) Int. Cl. B29C 37/00; G05D 23/19; B29C 67/00; G05B 15/02

(52) U.S. Cl. CPC B29C 37/0014; G05B 15/02; G05D 23/1917; B29C 67/0055; B29C 67/0085; B33Y 30/00

(57) ABSTRACT

A shaped object S is formed on a shaping table 10 which has attachably/detachably mounted thereon a base table 1 having a certain rigidity and a flexible table 2 having flexibility, the flexible table 2 is removed from the base table 1 with the shaped object S still mounted on the flexible table 2, the flexible table 2 is flexed to an opposite side from a fixing surface side of the shaped object S, and the shaped object S is removed from the flexible table 2.

### CROSS-REFERENCE TO RELATED APPLICATION

This application is based on and claims the benefit of priority from prior Japanese Patent Application No. 2014-236585, filed on Nov. 21, 2014, the entire contents of which are incorporated herein by reference.

### FIELD

The present invention relates to a shaping table employed by a three-dimensional shaping device, the three-dimensional shaping device, and a method of manufacturing a shaped object.

### BACKGROUND

A three-dimensional shaping device that manufactures a three-dimensional shaped object (hereinafter, referred to simply as shaped object) based on three-dimensional design data has been known by, for example, Japanese Patent No. 4860769. As a method for such a three-dimensional shaping device, various methods such as stereolithography, a powder sintering method, an ink jet method, and a fused deposition method have been proposed. Three-dimensional shaping devices using such methods have been brought to practical use.

In a three-dimensional shaping device adopting the fused deposition method, a shaping head for ejecting a molten resin, which will be a material of the shaped object, is mounted on a three-dimensional moving mechanism, and while the shaping head is moved in three-dimensional directions to eject the molten resin onto the likes of a table for shaping, the molten resin is laminated to obtain the shaped object.

In such a three-dimensional shaping device employing the fused deposition method, the molten resin is discharged at a temperature of not less than a pour point, but contracts when deposited to harden on the table, or the like. This contraction results in occurrence of the following problem, namely that a position of the shaped object during shaping gets misaligned, or in an extreme case, the shaped object gets displaced from the table.

Moreover, in such a three-dimensional shaping device, the following problem also ends up occurring, namely that if adhesion between the ejected resin and the table is too strong, the table ends up warping by hardening contraction of the resin and colliding with the shaped object during movement of the shaping head. For example, if a warping of the table of 0.1 mm has occurred with respect to before shaping, then, since a clearance setting of the head and the table is usually 0.05 to 0.5 mm, a possibility of collision is extremely high and there is also of the head getting broken.

On the other hand, when rigidity of the table has been raised so as to resist a warping force of a shaped resin, if an adhesive force with the table is high, then it becomes difficult for the shaped object to be peeled off when removing the shaped object after completion. If the shaped object is forcibly peeled off, then the following trouble ends up occurring, namely that the shaped object is broken or that damage ends up being caused to the table, whereby a second shaping cannot be performed.

Thus adhesive force and rigidity of the table are in a trade-off relationship, and this was a problem that could not be solved in a conventional shaping table. In addition, this problem increases as shaping size becomes larger, hence there was also a problem that manufacturing of a large-scale shaped object was made more difficult.

### BRIEF DESCRIPTION OF THE DRAWINGS

FIG. 1 is a perspective view showing a schematic configuration of a 3D printer employed in a first embodiment.

FIG. 2 is an enlarged front view of a shaping table according to the first embodiment.

FIG. 3 is a front view showing a schematic configuration of a three-dimensional shaping device employed in the first embodiment.

FIG. 4 is a perspective view showing a configuration of an XY stage.

FIG. 5 is a schematic view explaining a structure of a shaping head.

FIG. 6 is a block diagram explaining details of structure of a driver.

FIG. 7A is an explanatory view of a method of manufacturing a shaped object according to the first embodiment, being a state where shaping of the shaped object has been completed on the shaping table.

FIG. 7B is an explanatory view of a method of manufacturing a shaped object according to the first embodiment, being a state where a flexible table has been removed from a base table with the shaped object still mounted on the flexible table.

FIG. 7C is an explanatory view of a method of manufacturing a shaped object according to the first embodiment, being a state where the flexible table is being flexed to remove the shaped object.

FIG. 8 is an enlarged front view of a shaping table according to a second embodiment.

FIG. 9 is a schematic view showing a plane adjusting mechanism of a shaping table according to a third embodiment.

### DETAILED DESCRIPTION

A shaping table of the present invention comprises: a base table that has a certain rigidity; and a flexible table that has flexibility, is mounted attachably/detachably above the base table and is configured such that a shaped object is formed on a surface of the flexible table, the base table comprising an adjusting mechanism that adjusts a flatness of the flexible table. Moreover, a three-dimensional shaping device of the present invention comprises such a shaping table.

In addition, a method of manufacturing a shaped object of the present invention comprises: forming the shaped object on a shaping table, the shaping table having a base table and a flexible table mounted attachably/detachably thereon, the base table having a certain rigidity, and the flexible table having flexibility; removing the flexible table from the base table with the shaped object still mounted on the flexible table; and flexing the flexible table to remove the shaped object from the flexible table.

According to the present invention, warping of the shaped object hardly occurs and the shaped object may be easily removed.

Next, three-dimensional shaping devices (3D printers 100), shaping tables, and methods of manufacturing a shaped object according to embodiments of the present invention will be described in detail with reference to the drawings.

### First Embodiment

(Overall Configuration)

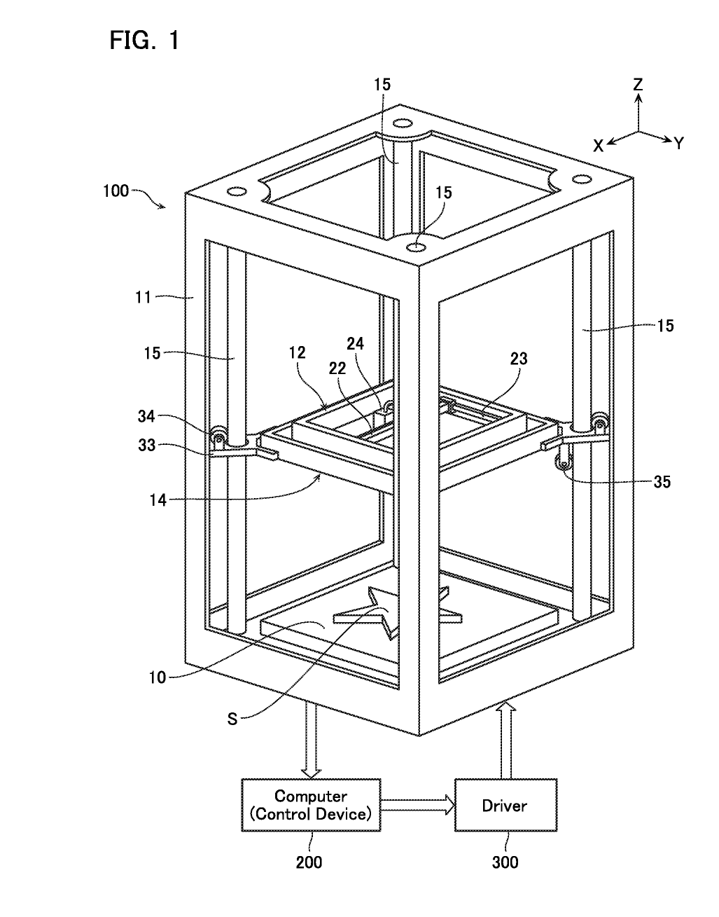

FIG. 1 is a perspective view showing a schematic configuration of a 3D printer 100 employed in the present embodiment. The 3D printer 100 comprises a separable type shaping table 10, a frame 11, an XY stage 12, an ascending/descending table 14, and guide shafts 15.

A computer 200 is connected to the 3D printer 100 as a control device that controls the 3D printer 100. Moreover, a driver 300 for driving various kinds of mechanisms in the 3D printer 100 is also connected to this 3D printer 100.

(Shaping Table 10)

The shaping table 10 is a stand on which a shaped object S is placed, and is a stand where a thermoplastic resin discharged from a shaping head, which will be described later, is deposited.

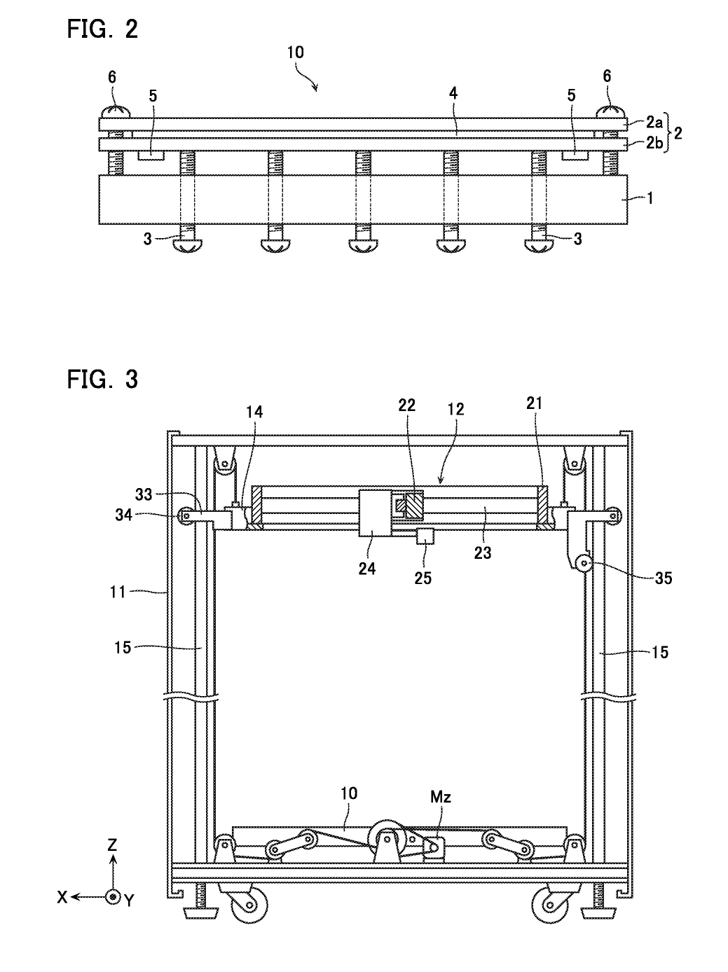

FIG. 2 is an enlarged front view of the shaping table 10 according to the present embodiment. The shaping table 10 of the present embodiment is configured as a separable type shaping table comprising: a base table 1; and a flexible table 2 mounted attachably/detachably on the base table 1.

The base table 1 is formed by a metal material of high rigidity such as stainless steel having a proof stress of not less than 250 N/m2, and a thickness of not less than about 3 mm. The base table 1 has numerous support bolts 3 (support members) mounted therein by being screwed in from a lower surface side of the base table 1, and end portions of the support bolts 3 protrude from an upper surface of the base table 1 to abut on the flexible table 2, and support the flexible table 2 while enabling a height of the flexible table 2 to be adjusted by the support bolts 3. Moreover, the end portion of the support bolt 3 is formed in a plane so as to lower a surface pressure.

The flexible table 2 is configured from a pair of flat plate bodies 2a and 2b having flexibility. It is desirably configured from a material for which an elastic deformation region of the flexible table 2 occupies a broader range than an elastic deformation region of the base table 1 in a stress-strain curve as a physical property of a material particularly indicating flexibility. For example, the flat plate bodies 2a and 2b may be formed by a metal material having flexibility or a resin plate. Employable as the metal material having flexibility are the likes of heat-resistant aluminum such as #3003 or SUS (various kinds of stainless steel materials), a spring material of the likes of phosphor bronze, a magnesium alloy, and so on. Moreover, employable as the resin plate are a combination of the likes of polyethylene terephthalate (PET) film or acrylic resin, vinyl chloride resin, polypropylene, polycarbonate, fluororesin (PTFE), and so on.

The flat plate bodies 2a and 2b may also be configured as an identical metal material, and in that case, an aluminum plate having a thickness of about 1.5 mm is preferably employed. In addition, it is also possible for the flat plate body 2a to be configured as a metal material having flexibility and the flat plate body 2b as a resin plate, or conversely for the flat plate body 2a to be configured as a resin plate and the flat plate body 2b as a metal material having flexibility. The flexible table 2 due to the above-described configuration enables load distortion to be reduced. Moreover, when the flat plate bodies 2a and 2b are configured by an identical metal material, warping due to a difference in thermal expansion coefficients of materials can be further suppressed. Note that when the flat plate bodies 2a and 2b are both configured by a resin plate, load resistance distortion ends up increasing, hence it is desirable that at least one is configured by a metal material having flexibility. However, a configuration in which the flat plate body 2a is configured as a metal material and a thin resin material or metal material is attached onto the flat plate body 2a, is also possible.

In addition, a flat plate type heater 4 for heating the flexible table 2 is provided between the pair of flat plate bodies 2a and 2b. The flat plate type heater 4 may employ the likes of a nichrome material or stainless steel material. Furthermore, for example, both ends on a lower surface side of the flat plate body 2b may be provided with a temperature sensor 5 for temperature measurement of the flexible table 2. The flat plate type heater 4 and the temperature sensor 5 are connected to the computer (control device) 200 and are configured capable of controlling the flexible table 2 to a certain temperature. Moreover, attaching bolts 6 are screwed in to both ends of the flexible table 2, and the flexible table 2 is fastened and fixed onto the base table 1.

(Frame 11)

As shown in FIG. 1, the frame 11 has, for example, a rectangular parallelepiped outer shape, and comprises a framework of a metal material such as aluminum. For example, four of the guide shafts 15 are formed at four corner portions of this frame 11, so as to extend in a Z direction of FIG. 1, that is, a direction perpendicular to a plane of the shaping table 10. As will be described later, the guide shafts 15 are linear members that specify a direction of moving the ascending/descending table 14 in an up-and-down direction. The number of guide shafts 15 is not limited to four, and is set to a number that enables the ascending/descending table 14 to be stably maintained and moved.

(Ascending/Descending Table 14)

As shown in FIGS. 1 and 3, the ascending/descending table 14 is penetrated by the guide shafts 15 at its four corner portions, and is configured capable of moving along a longitudinal direction (Z direction) of the guide shafts 15. The ascending/descending table 14 comprises rollers 34 and 35 that contact the guide shafts 15. As a result of these rollers 34 and 35 rotating while making contact on the guide shafts 15, the ascending/descending table 14 is enabled to move smoothly in the Z direction. Moreover, as shown in FIG. 3, as a result of a driving force of a motor Mz being transmitted by a power transmission mechanism configured from the likes of a timing belt, a wire, and a pulley, the ascending/descending table 14 moves in the up-and-down direction at certain intervals (for example, 0.1 mm pitches). The motor Mz is preferably, for example, a servo motor, a stepping motor, or the like.

(XY Stage 12)

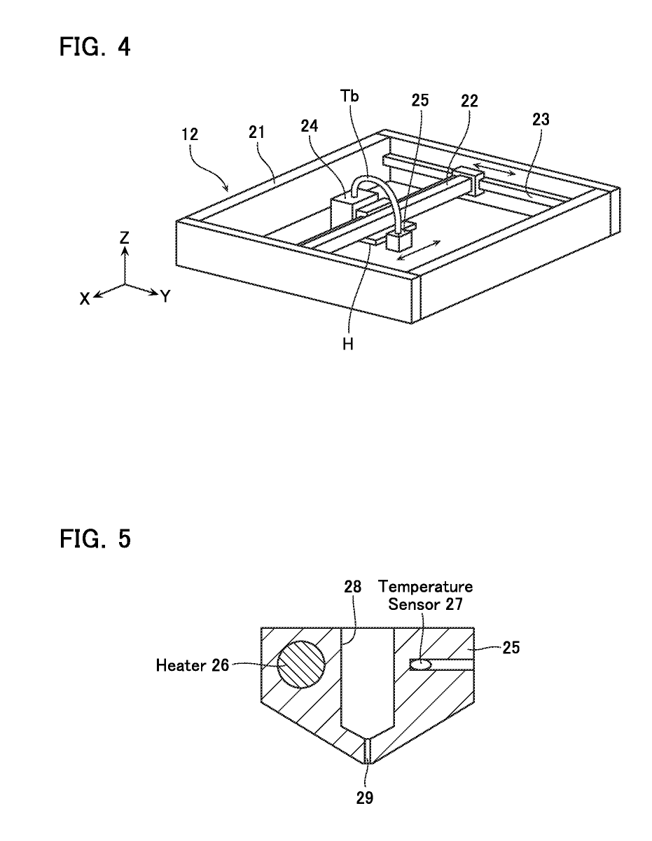

The XY stage 12 is placed on an upper surface of this ascending/descending table 14. FIG. 4 is a perspective view showing a schematic configuration of this XY stage 12. The XY stage 12 comprises a frame body 21, an X guide rail 22, a Y guide rail 23, a filament holder 24, a shaping head 25, and a shaping head holder H. The X guide rail 22 has its both ends engaged by the Y guide rail 23 and is held slidably in the Y direction. The filament holder 24 is a container for holding and supplying to the shaping head 25 the thermoplastic resin (filament) that will be a material of the shaped object S. In addition, although illustration thereof is omitted in FIG. 1, the filament is held in a form of being wound by a roller held above the frame 11, for example, and is sent to the filament holder 24 as required.

(Shaping Head 25)

The filament is supplied from the filament holder 24 to the shaping head 25 via a tube Tb. The shaping head 25 is held by the shaping head holder H, and is configured capable of moving, together with the filament holder 24, along the X and Y guide rails 22 and 23. The shaping head 25 need only be configured capable of moving together with the shaping head holder H maintaining a constant positional relationship between the two in the XY plane, but may be configured such that the positional relationship between the two is changeable also in the XY plane.

Note that although illustration thereof is omitted in FIGS. 3 and 4, motors Mx and My for moving the shaping head 25 with respect to the XY stage 12 are also provided on this XY stage 12. Moreover, although illustration thereof is omitted, a motor Mr for raising/lowering the shaping head 25 in the up-and-down direction (Z direction) with respect to the shaping head holder H is also mounted in this XY stage 12. The motors Mx, My, and Mr are preferably, for example, a servo motor, a stepping motor, or the like. Note that in this embodiment, to simplify description, one shaping head is adopted, but two or more shaping heads may be employed. In that case, the shaping heads 25 may be configured to be respectively supplied with filaments of different colors. Alternatively, the shaping heads 25 may be configured to be respectively supplied with filaments of different materials, for example.

FIG. 5 is a schematic view of a structure of the shaping head 25. The shaping head 25 comprises a heater 26, a temperature sensor 27, a molten resin holding portion 28, and a discharge hole 29. The heater 26 is for changing a temperature of the shaping head 25. Moreover, the temperature sensor 27 measures a temperature of a certain place of the shaping head 25 (a temperature of the shaping head 25 in a periphery of the temperature sensor 27) and feeds that measurement result back to the computer 200. In addition, the molten resin holding portion 28 is a portion entered by the previously mentioned filament. When the filament that has entered the molten resin holding portion 28 is heated by the heater 26, the filament melts, and the melted thermoplastic resin remains in the molten resin holding portion 28, and furthermore is discharged to outside from the discharge hole 29.

(Driver 300)

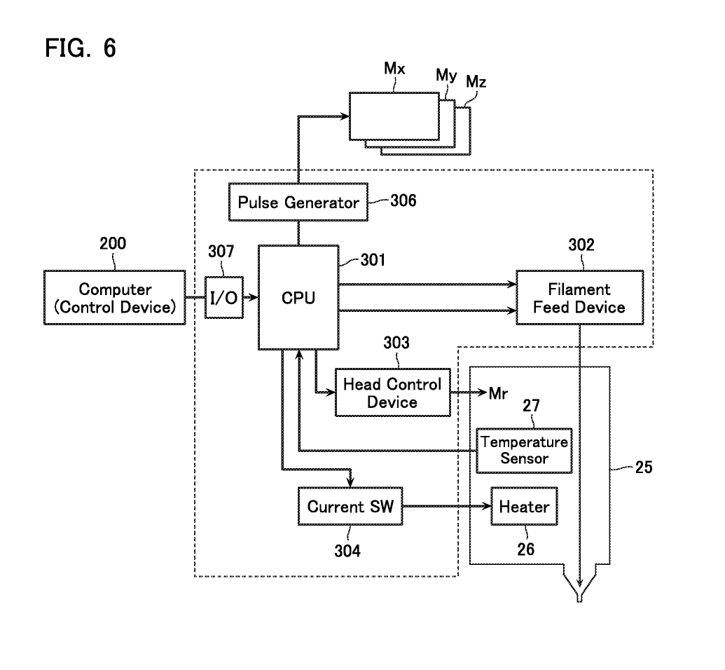

Next, details of structure of the driver 300 will be described with reference to the block diagram of FIG. 6. The driver 300 includes a CPU 301, a filament feed device 302, a head control device 303, a current switch 304, and a pulse generator 306.

The CPU 301 receives various kinds of signals from the computer 200 via an input/output interface 307 to perform overall control of the driver 300. The filament feed device 302 controls a sending amount (pushing amount or standby amount) to the shaping head 25 of the filament, based on a control signal from the CPU 301. Moreover, the head control device 303 controls a position of the shaping head 25 according to a control signal from the CPU 301. By the previously mentioned motor Mr being driven, the shaping head 25 descends to an operation position, and moreover after completion of a shaping operation, and so on, ascends to a standby position.

The current switch 304 is a switch circuit for switching a current amount flowing in the heater 26. By a switching state of the current switch 304 being switched, a current flowing in the heater 26 increases or decreases, whereby the temperature of the shaping head 25 changes. Moreover, the pulse generator 306, in accordance with a control signal from the CPU 301, generates a pulse signal for controlling the motors Mx, My, and Mz.

(Method of Shaping)

Next, a method of shaping the shaped object S employing the 3D printer 100 configured as described above, will be described.

First, the pulse generator 306, in accordance with a control signal from the CPU 301, generates a pulse signal for controlling the motors Mx, My, and Mz. As a result of this pulse signal, the motor Mz, due to its driving force being transmitted by the power transmission mechanism configured from the likes of a timing belt, a wire, and a pulley, moves the ascending/descending table 14 in the Z direction (up-and-down direction). In addition, as a result of this pulse signal, the motors Mx and My move the shaping head 25 to a certain position in the XY stage 12. Furthermore, if desired, the head control device 303, in accordance with a control signal from the CPU 301, raises and lowers the shaping head 25 with respect to the shaping head holder H in the up-and-down direction (Z direction).

On the other hand, when the filament that has entered the molten resin holding portion 28 in the shaping head 25 is heated by the heater 26, the filament melts, and the melted thermoplastic resin remains in the molten resin holding portion 28, and furthermore is discharged to outside from the discharge hole 29.

By ejecting the molten resin onto the shaping table 10 and laminating the molten resin while moving the shaping head 25 to a three-dimensional certain position in this way, the shaped object S is obtained.

(Method of Using Separable Type Shaping Table 10)

Next, a method of using the separable type shaping table 10 will be described.

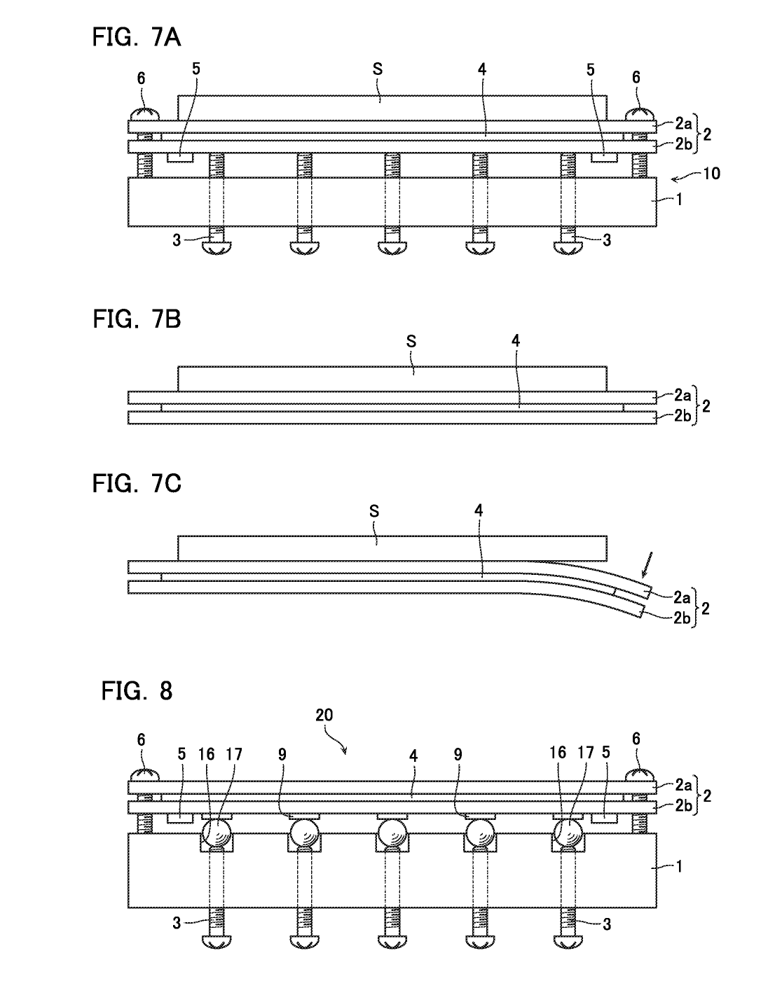

The shaped object S is formed, by the above-mentioned method, on the shaping table 10 in a state where the base table 1 and the flexible table 2 are fastened by the attaching bolts 6 as shown in FIG. 2 (refer to FIG. 7A). During shaping, a flatness of the flexible table 2 is pre-adjusted by adjusting in advance heights of the support bolts 3. Moreover, the temperature of the flexible table 2 is measured by the temperature sensor 5 and the flat plate type heater 4 is employed to pre-set the temperature of the flexible table 2 to be a temperature corresponding to a discharge temperature of the molten resin.

After completion of shaping, the attaching bolts 6 are loosened, and the flexible table 2 with the shaped object S still mounted thereon is removed from the base table 1 (refer to FIG. 7B). Note that the flat plate body 2a only, of the flexible table 2, may be removed.

Next, as shown in FIG. 7C, one end of the flexible table 2 is applied with a stress in a direction of the arrow, whereby the flexible table 2 is flexed to an opposite side from a fixing surface side of the shaped object S and the flexible table 2 is gradually peeled from the shaped object S. By doing so, the shaped object S can be removed without being applied with a stress.

(Advantages)

The shaping table 10 according to the present embodiment enables the following advantages to be displayed.

(1) During shaping, the shaped object is formed in a state where the base table 1 and the flexible table 2 are fastened by the attaching bolts 6, hence action of the base table 1, which has high rigidity, makes it possible to suppress the flexible table 2 warping or deforming due to a warping force of the shaped resin.

(2) The flexible table 2 is configured from the pair of flat plate bodies 2a and 2b, which are thin, and the flat plate type heater 4 is disposed between them, hence temperature controllability of the flexible table 2 is more improved compared to a conventional high rigidity table of large thickness. Therefore, it becomes possible to highly precisely control the temperature of the flexible table 2 to a hardening temperature (not more than a glass transition point) of the resin, a contraction amount during resin hardening can be suppressed, and warping of the shaped object S can be reduced. Moreover, a volume of the flexible table 2 is small, hence wasted electric power of the flat plate type heater 4 can be suppressed, which also contributes to energy saving.

(3) After completion of shaping, the flexible table 2 (or flat plate body 2a) can be removed from the base table 1 with the shaped object S still mounted on the flexible table 2. As a result, by applying a stress to one end of the pair of flat plate bodies 2 (or flat plate body 2a) having flexibility, the flexible table 2 (or flat plate body 2a) is flexed to an opposite side from a fixing surface side of the shaped object S and the flexible table 2 (or flat plate body 2a) can be gradually peeled from the shaped object S. Therefore, since the shaped object S is not applied with a stress, the shaped object S can be easily removed without any accompanying damage.

(4) When an end portion of the support bolt 3 is configured in a pointed shape, it results in point contact with the flat plate body 2b, and there is a risk of an applied pressure becoming abnormally large. However, by configuring the end portion of the support bolt 3 as a surface formed in a plane, contact area with the flat plate body 2b of the flexible table 2 can be broadened and surface pressure can be lowered.

(5) So far, the shaping table and the three-dimensional shaping device employing the shaping table, of the present invention, have been described. Some additional explanation regarding advantages of the shaping table which is the key point of the present invention, will be provided. In the present invention, the shaping table, which was conventionally a single configuration, is divided into the two configurations of the base table 1 and flexible table 2, and conventional problems are solved by disposing the flexible table 2 so as to contact the shaped resin. Three-dimensional shaping is frequently performed under a high temperature environment of from 100° C. to 180° C., and a temperature strain also occurs in the shaping table due to a temperature difference with room temperature. However, the configuration and method of adjusting of the present invention enable deformation to be suppressed and flatness to be maintained. That is, by adjusting an envelope surface of support bolt 3 tops protruding from the base table 1, a surface contacting the shaped resin of the flexible table 2 can be adjusted in advance to an ideal plane, and internal strain can be corrected and, furthermore, a position of the flexible table 2 can be firmly fixed.

(6) In addition, due to shaping advancing, a gravity center is formed in the shaped object S, and furthermore, depending on a shape of the shaped object S, the gravity center moves during shaping. However, even in this state, a plane is maintained. Moreover, removal of the shaped object S is simply achieved by separating the flexible table 2 and base table 1 and flexing the flexible table 2, and the flexible table 2, due to flexibility thereof, can have its plane restored and can be re-used.

Note that previously it was assumed that the flexible table 2 is desirably configured from a material for which an elastic deformation region of the flexible table 2 is broader than an elastic deformation region of the base table 1 in a stress-strain curve as a physical property of a material indicating flexibility. When a variety of shaped objects S are shaped by the present device, a deformation amount of the flexible table 2 required for peeling changes according to a height or area contacting the flexible table 2, and an adhesive force with the flexible table 2, of a final shaped object S, hence the material of the flexible table 2 is most desirably configured as a material having an elastic deformation region that exceeds that minimum required deformation amount. In other words, the material of the flexible table 2 is a material having an elastic deformation region that exceeds a deformation amount for peeling determined according to the height or area contacting the flexible table 2, and the adhesive force with the flexible table 2, of the final shaped object.

### Second Embodiment

Next, a three-dimensional shaping device, a shaping table, and a method of manufacturing a shaped object according to a second embodiment will be described with reference to FIG. 8. This second embodiment has a shaping table which differs from that of the first embodiment. A structure other than the shaping table of the three-dimensional shaping device and the method of manufacturing the shaped object may be substantially identical to those of the first embodiment, hence descriptions thereof will be omitted. Moreover, in FIG. 8, configurations identical to those of the first embodiment are assigned with reference symbols identical to those assigned in the first embodiment, and detailed descriptions thereof will be omitted below.

FIG. 8 shows an example of a shaping table 20 according to the second embodiment.

This shaping table 20 according to the second embodiment has recesses 16 provided at fixed intervals in the surface of the base table 1, and has ball-shaped movable members 17 respectively inserted in these recesses 16. An upper end of a support bolt 3 similar to that of the first embodiment abuts on a lower end of this movable member 17. The upper end of the movable member 17 abuts on a lower surface of the flat plate body 2b of the flexible table 2, via a movable plate 9. Therefore, when a position of the support bolt 3 is adjusted, a position in the recess 16 of the movable member 17 is changed in the up-and-down direction, whereby the movable plate 9 moves and flatness of the flexible table 2 may be adjusted. Configurations excluding the above-described ones are configured similarly to in the shaping table 10 of the first embodiment (FIG. 2).

The shaping table 20 makes it possible for height of the flexible table 2 to be adjusted by adjusting the positions of the movable members 17 by the numerous support bolts 3 screwed in from the lower surface side of the base table 1. Moreover, contact area with the flat plate body 2b of the flexible table 2 can be broadened and surface pressure can be lowered by having the movable plate 9 interposed. Note that the movable member 17 is not limited to having a ball shape (completely round shape), and that movable members 17 of a variety of shapes, such as an elliptical shape and a rectangular shape, may be adopted.

### Third Embodiment

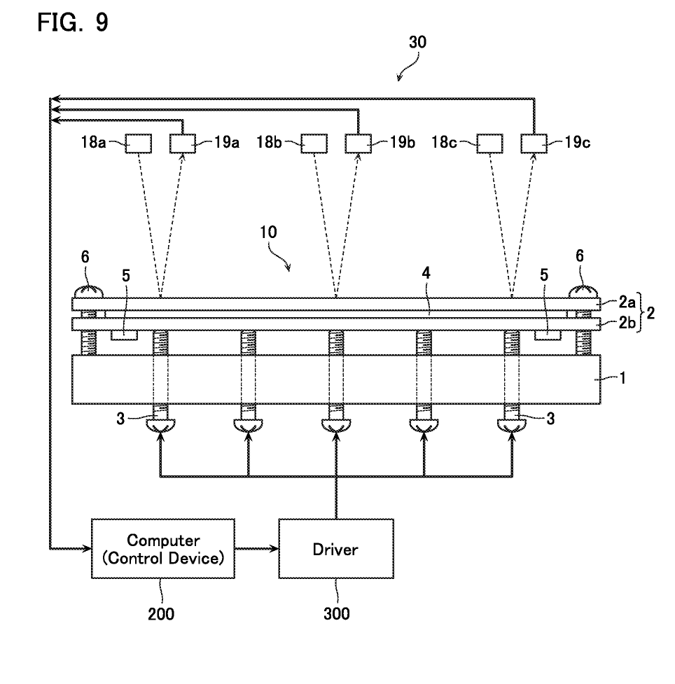

Next, a three-dimensional shaping device, a shaping table, and a method of manufacturing a shaped object according to a third embodiment will be described with reference to FIG. 9. This third embodiment has a shaping table which differs from that of the first embodiment. More specifically, this third embodiment differs from the previously described embodiments in being provided with a mechanism that automatically adjusts flatness of the flexible table 2. A structure other than the shaping table, of the three-dimensional shaping device and the method of manufacturing the shaped object may be substantially identical to those of the first embodiment, hence descriptions thereof will be omitted. Moreover, in FIG. 9, configurations identical to those of the first embodiment are assigned with reference symbols identical to those assigned in the first embodiment, and detailed descriptions thereof will be omitted below.

FIG. 9 shows an example of a plane adjusting mechanism of the shaping table according to the third embodiment.

In this embodiment, plane sensors, each comprising a pair of a light emitter 18a (18b, 18c) and a light receiver 19a (19b, 19c), are provided at certain intervals above the shaping table 10, and the light receiver 19a (19b, 19c) of each of the plane sensors is connected to the computer (control device) 200 for analyzing a received light amount. Moreover, the driver 300 that controls the position of the support bolt 3 is connected to the computer (control device) 200. Now, the light emitters 18a, 18b, and 18c may employ a laser light source, a light emitting element, or the like.

In a plane adjusting mechanism 30 of this shaping table, light generated by the light emitters 18a, 18b, and 18c is reflected by the surface of the flexible table 2 and received by the light receivers 19a, 19b, and 19c. Now, if the surface of the flexible table 2 has a place which is not flat, a change occurs in the amount of light received by the light receivers 19a, 19b, and 19c. The computer (control device) 200 detects a flatness by analyzing this change amount, and issues an instruction to the driver 300 to adjust a height of the support bolt 3 such that the flatness becomes flatter. As a result, a measurement result of the plane sensor is received, whereby the height of the support bolt can be automatically adjusted and flatness can be improved.

Note that in this embodiment, the shaping table 10 shown in the first embodiment was employed, but a similar configuration may be adopted even if the shaping table 20 shown in the second embodiment is employed.

### Other Embodiments

That concludes description of each of the embodiments, but, for example, the following kinds of modifications, substitutions, additions, and so on, are possible in these embodiments.

(1) In the above-described embodiments, a single flat plate type heater 4 was provided between the flat plate bodies 2a and 2b, but it is also possible for a plurality of heaters such as linear type ones to be provided and temperature control performed for each.

(2) In the above-described embodiments, the flat plate type heater 4 was provided fixed between the flat plate bodies 2a and 2b, but the heater may be attachable/detachable.

(3) Numbers, thicknesses, and dimensions of the flat plate bodies 2a and 2b of the flexible table 2 may be appropriately determined as required.

(4) In the above-described embodiments, two temperature sensors 5 were provided at both ends on the lower surface side of the flat plate body 2b, but the number and arrangement places of the temperature sensors 5 may be set arbitrarily.

(5) In the above-described embodiments, the flexible table 2 was fixed on the base table 1 using the attaching bolt 6, but it may be fixed employing another fixing means (for example, a bolt and nut, a clip, a wire, a magnet, a pin, and so on), not only the attaching bolt 6.

(6) In the above-described embodiments, adjustment was performed by the support bolt 3 screwed in from the lower surface side of the base table 1, but a configuration may be adopted enabling adjustment from an upper surface side of the base table 1. In that case, the support bolt 3 may be given a structure not penetrating the base table 1.

(7) While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A shaping table for a three-dimensional shaping device, the shaping table comprising:
a base table having a certain rigidity; and a flexible table having flexibility, the flexible table being mounted attachably/detachably above the base table and being configured such that a shaped object is formed on a surface of the flexible table,
the base table comprising an adjusting mechanism that adjusts a flatness of the flexible table.

2. The shaping table according to claim 1, wherein
the adjusting mechanism comprises a plurality of support members that support the flexible table, and an end portion of the support member is configured so as to protrude from an upper surface of the base table and abut on the flexible table.

3. The shaping table according to claim 2, wherein
the end portion of the support member is formed in a plane.

4. The shaping table according to claim 1, wherein
the flexible table includes: a first flat plate body on a side where the shaped object is formed; and a second flat plate body on a side on which the support member abuts, and at least one of the first and second flat plate bodies is formed by a metal material having flexibility.

5. The shaping table according to claim 1, wherein
the flexible table further comprises:
a temperature detecting device that detects a temperature of the flexible table; and
a heating device that heats the flexible table.

6. The shaping table according to claim 5, further comprising
a control device on an inside or an outside of the flexible table, the control device controlling the heating device according to a detection result of the temperature detecting device.

7. The shaping table according to claim 1, wherein
the adjusting mechanism comprises a plurality of support members that penetrate the base table from a lower surface side of the base table and have end positions are adjustable in position, and
an end portion of the support member is configured so as to protrude from an upper surface of the base table and abut on the flexible table.

8. A three-dimensional shaping device, comprising:
a shaping table on which a shaped object is formed; and
a shaping head that discharges to the shaping table a molten resin for forming the shaped object,
the shaping table comprising:
a base table that has a certain rigidity; and a flexible table that has flexibility, is mounted attachably/detachably above the base table and is configured such that the shaped object is formed on a surface of the flexible table, and
the base table comprising an adjusting mechanism that adjusts a flatness of the flexible table.

9. The three-dimensional shaping device according to claim 8, wherein
the adjusting mechanism comprises a plurality of support members that support the flexible table, and an end portion of the support member is configured so as to protrude from an upper surface of the base table and abut on the flexible table.

10. The three-dimensional shaping device according to claim 9, wherein
the end portion of the support member is formed in a plane.

11. The three-dimensional shaping device according to claim 8, wherein
the flexible table includes: a first flat plate body on a side where the shaped object is formed; and a second flat plate body on a side on which the support member abuts, and at least one of the first and second flat plate bodies is formed by a metal material having flexibility.

12. The three-dimensional shaping device according to claim 8, wherein
the flexible table further comprises:
a temperature detecting device that detects a temperature of the flexible table; and
a heating device that heats the flexible table.

13. The three-dimensional shaping device according to claim 12, further comprising
a control device on an inside or an outside of the flexible table, the control device controlling the heating device according to a detection result of the temperature detecting device.

14. The three-dimensional shaping device according to claim 8, wherein
the adjusting mechanism comprises a plurality of support members that penetrate the base table from a lower surface side of the base table and have end positions are adjustable in position, and
an end portion of the support member is configured so as to protrude from an upper surface of the base table and abut on the flexible table.

15. A method of manufacturing a shaped object, comprising:
forming the shaped object on a shaping table, the shaping table having a base table and a flexible table mounted attachably/detachably thereon, the base table having a certain rigidity, and the flexible table having flexibility;
removing the flexible table from the base table with the shaped object still mounted on the flexible table; and
flexing the flexible table to remove the shaped object from the flexible table.
